(19) United States
(12) Patent Application Publication
(10) Pub. No.: US 2023/0418585 A1
(43) Pub. Date: Dec. 28, 2023

(54) METHOD FOR GENERATING UPDATE PACKAGE OF SOFTWARE

(71) Applicant: PAX COMPUTER TECHNOLOGY (SHENZHEN) CO., LTD., Shenzhen (CN)

(72) Inventors: Yanfei WANG, Shenzhen (CN); Lihong XIE, Shenzhen (CN); Chuan LIU, Shenzhen (CN)

(21) Appl. No.: 18/207,977

(22) Filed: Jun. 9, 2023

Related U.S. Application Data
(63) Continuation-in-part of application No. PCT/CN2021/124468, filed on Oct. 18, 2021.

(30) Foreign Application Priority Data
Dec. 11, 2020 (CN) 202011447046.X

(51) Int. Cl. G06F 8/65; G06F 8/61

(52) U.S. Cl. CPC G06F 8/65; G06F 8/61

(57) ABSTRACT

A method for generating an update package of software. Each installation package of the software includes multiple installation subpackages, and each installation subpackage includes multiple installation files. The method includes: obtaining first feature information and second feature information, the first feature information corresponds to the first installation subpackage, the second feature information corresponds to the second installation subpackage, the first installation subpackage is an installation subpackage in an installation package corresponding to a upgraded software version of the software, and the second installation subpackage is an installation subpackage corresponding to the first installation subpackage in an installation package corresponding to software version of the software before software upgrading; generating the update package for the software according to the first installation subpackage when the first feature information is different from the second feature information. This method can improve an efficiency of generation of the update package of the software.

### CROSS-REFERENCE TO RELATED APPLICATIONS

This application is a continuation-in-part of PCT patent application Serial No. PCT/CN2021/124468, filed on Oct. 18, 2021, which claims priority to Chinese patent application No. 202011447046.X, filed with CNIPA on Dec. 11, 2020, the entire contents each of which are incorporated herein by reference.

### FIELD

The present application relates to the field of computer technologies, and more particularly, to a method for generating an update package of software.

### BACKGROUND

Currently, software versions can be updated through an incremental upgrade method. The incremental upgrade refers to differentiating a new version installation package of the software from an old version installation package of the software, determining updated files, packaging the updated files, and generating an incremental upgrade package. When differentiating the new version installation package of the software from the old version installation package of the software, files in the new version installation package need to be compared one by one with the files in the old version installation package one by one. With the update of software versions, files in the installation package are increasing. This method for differentiating installation packages of different versions is slower and requires more server resources.

### SUMMARY

Embodiments of the present application provide a method for generating an update package of software, this method can reduce resource consumption of a server and improve an efficiency of generation of update package of the software.

According to the first aspect of the embodiments of the present application, a method for generating an update package of software is provided. Each installation package of the software includes multiple installation subpackages, and each of the multiple installation subpackages includes multiple installation files. The method includes:
receiving, by the version upgrade server, an identifier and current version information of the software from a terminal device;
determining, by the version upgrade server, an installation package corresponding to a latest version of the software according to the identifier, and determining an installation package corresponding to a current version of the software according to the current version information;
obtaining, by the version upgrade server, first feature information and second feature information according to the installation package corresponding to the latest version of the software and the installation package corresponding to the current version of the software; the first feature information corresponds to a first installation subpackage, the second feature information corresponds to a second installation subpackage, the first installation subpackage is an installation subpackage in an installation package of an upgraded software version of the software, and the second installation subpackage is an installation subpackage corresponding to the first installation subpackage in an installation package of a software version of the software before upgrading; and
generating, by the version upgrade server, an update package for the software according to the first installation subpackage when the first feature information is different from the second feature information.

In some embodiments, said obtaining, by the version upgrade server, the first feature information and the second feature information according to the installation package corresponding to the latest version of the software and the installation package corresponding to the current version of the software includes:
by the version upgrade server, obtaining a first identifier from a first software installation package and obtaining a second identifier from a second software installation package; the first software installation package is the installation package corresponding to the upgraded software version of the software, and the second software installation package is the installation package corresponding to the software version of the software before upgrading; the first identifier is used to indicate the first installation subpackage, the second identifier is used to indicate the second installation subpackage, and the first identifier is the same as the second identifier; and
by the version upgrade server, determining feature information corresponding to the first identifier as the first feature information, and determining feature information corresponding to the second identifier as the second feature information.

In some embodiments, said generating, by the version upgrade server, the update package of the software according to the first installation subpackage comprises:
packaging, by the version upgrade server, an installation file of the first installation subpackage that is different from the second installation subpackage to generate the update package of the software.

In some embodiments, the first feature information is determined according to multiple version information corresponding to multiple installation files in the first installation subpackage.

In some embodiments, the second feature information is determined according to multiple version information corresponding to multiple installation files in the second installation subpackage.

In some embodiments, the method further includes: generating the first feature information according to a first sequence, and generating the second feature information according to a second sequence when a first installation file in the first installation subpackage is the same as a second installation file in the second installation subpackage. The first sequence is the same as the second sequence, the first sequence corresponds to multiple version information that corresponds to multiple installation files in the first installation subpackage, and the second sequence corresponds to multiple version information that corresponds to multiple installation files in the second installation subpackage; the first installation file is any one of the multiple installation files in the first installation subpackage.

According to the second aspect of the embodiments of the present application, a device is provided. This device includes a memory, a processor and a computer program stored in the memory and executable by the processor. The processor is configured to, when executing the computer program, implement the method for generating update package of software described in the first aspect.

According to the third aspect of the embodiments of the present application, a computer-readable storage medium is provided. The computer-readable storage medium store an instruction, that, when executed by a computer, causes the computer to perform the method for generating update package of software described in the first aspect.

According to the fourth aspect of the embodiments of the present application, a computer program product is provided. The computer program product stores a computer program, that, when executed by a processor, causes the processor to implement the method for generating update package of software described in the first aspect.

The embodiments of the present application provide the method for generating update package of software in which the installation package of the software is divided into multiple installation subpackages, and each of the installation subpackages includes multiple installation files. When generating the update package of the software, if the first feature information is different from the second feature information, the update package of the software is generated according to the first installation subpackage. According to this method provided in the embodiment of the present application, one installation subpackage corresponds to one feature information, the first installation subpackage and the second installation subpackage are compared according to the first feature information and the second feature information, the time spent on comparing installation files of the two versions is greatly reduced, resource consumption of the server is reduced accordingly, and the efficiency of generation of update package of the software is improved.

### BRIEF DESCRIPTION OF THE DRAWINGS

In order to describe the embodiments of the present application more clearly, a brief introduction regarding the accompanying drawings that need to be used for describing the embodiments of the present application or the prior art is given below. It is obvious that the accompanying drawings described below are merely some embodiments of the present application, a person of ordinary skill in the art may also acquire other drawings according to the current drawings without paying creative efforts.

FIG. 1 illustrates a schematic flow diagram of a method 100 for generating update package of software in accordance with one embodiment of the present application;

FIG. 2 illustrates a schematic diagram of dividing of the installation package of the software in accordance with one embodiment of the present application;

FIG. 3 illustrates a schematic flow diagram of a software upgrading method 300 in accordance with one embodiment of the present application;

FIG. 4 illustrates a schematic flow diagram of a software upgrading method 400 in accordance with one embodiment of the present application; and

FIG. 5 illustrates a schematic structural diagram of a device for generating update package of software in accordance with one embodiment of the present application.

### DETAILED DESCRIPTION OF EMBODIMENTS

In order to make the objective, the technical solutions and the beneficial effects of the present application be clearer and more understandable, the present application is further described in detail below with reference to the accompanying figures and the embodiments. It should be understood that the embodiments described herein are only intended to illustrate but not to limit the present application.

Terms such as “the first” and “the second” described below are only used for the purpose of illustration, and thus should not be considered as indicating or implying any relative importance, or implicitly indicating the number of indicated technical features. Thus, technical feature(s) restricted by “the first” or “the second” can explicitly or implicitly comprise one or more such technical feature(s). In the description of the present application, the meaning of the term “a plurality of” is at least two, unless otherwise there is additional explicit and specific limitation for the term of “a plurality of”.

Usually, a released version of large software has many files after being installed on a terminal device. For example, hundreds of various files are included in an operating system. When a software version of the software is updated, it is generally not necessary to modify all files in the installation package of the software, it only needs to update some files in the installation package of the software.

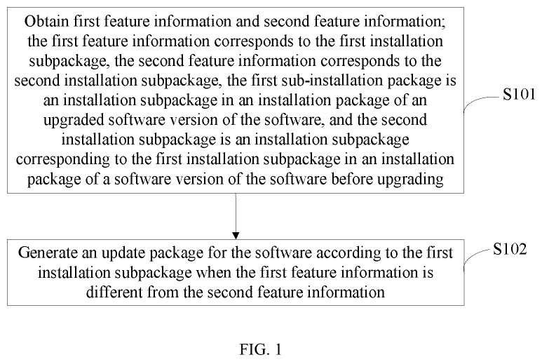

FIG. 1 is a schematic flow diagram of a method 100 for generating an update package of software provided in one embodiment of the present application. This method 100 includes at least the following steps:

In a step of S101, first feature information and second feature information are obtained. The first feature information corresponds to a first installation subpackage, the second feature information corresponds to a second installation subpackage, the first installation subpackage is an installation subpackage in an installation package of an upgraded software version of the software, and the second installation subpackage is an installation subpackage corresponding to the first installation subpackage in the installation package of the software version of the software before software upgrading.

In a step of S102, the update package of the software is generated according to the first installation subpackage when the first feature information is different from the second feature information.

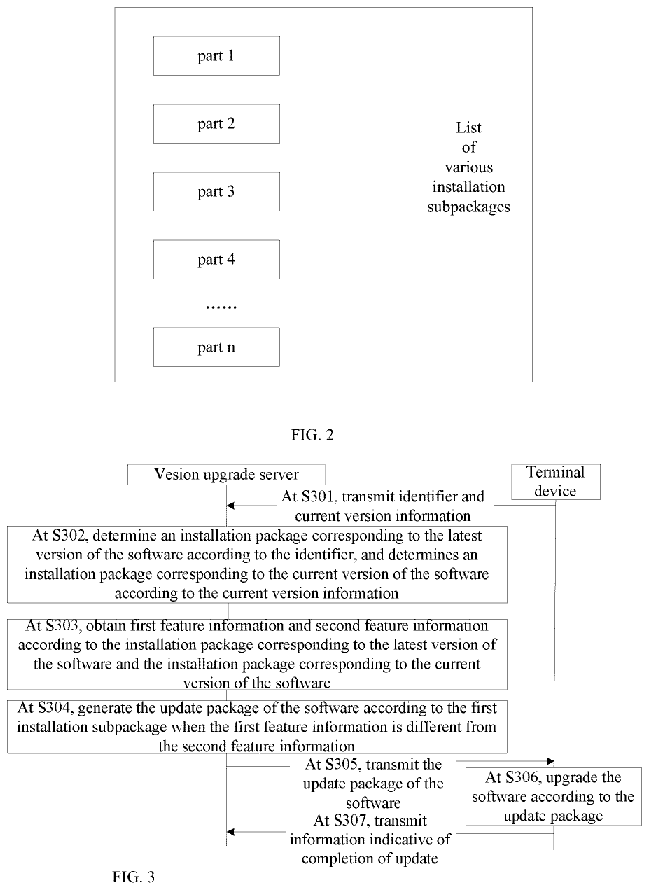

In this embodiment of the present application, software may have multiple versions, and each software version corresponds to one installation package. When an installation package of the software is generated, as shown in FIG. 2, all installation files to be packaged into the installation package are classified according to a certain rule, and the overall installation package of the software is divided into n installation subpackages such as part 1, part 2, . . . , part n, etc. Each installation subpackage includes multiple installation files. The rule for dividing the installation subpackages may be the rule according to the functionalities of modules, the types of installation files, or be the rule according to the sources of the installation files, etc. For example, according to the functionalities of the modules, all installation files in the installation package of the software can be divided into four parts of Kernel, Ramdisk, Base, and Spos. Kernel contains system kernel files, Ramdisk contains root file system, Base contains system basic library files, and Spos contains security processor system files. After the dividing of the installation subpackages, feature information of the installation subpackages is generated. One installation subpackage corresponds to one feature information.

In this embodiment of the present application, the installation package corresponding to the upgraded software version of the software is marked as the first software installation package, and the installation package corresponding to the software version of the software before software upgrading is marked as the second software installation package. The first software installation package includes n installation subpackages, which are labeled as part 1, part 2, . . . , and part n. The second software installation package includes n installation subpackages, which are labeled as part 1′, part 2′, . . . , part n′, part n corresponds to Part n′. A correspondence relationship between part n′ and part n can be determined through various methods such as a dividing rule, a mapping table, and identifiers.

When generating the update package of the software, the first feature information is obtained from the first software installation package, and the second feature information is obtained from the second software installation package. The first feature information corresponds to the first installation subpackage, and the second feature information corresponds to the second installation subpackage. The first installation subpackage is one of n installation subpackages included in the first software installation package (e.g., part 1). The second installation subpackage is an installation subpackage corresponding to the first installation subpackage in the second software installation package (e.g., part 1′).

Whether the first feature information is the same as the second feature information is determined. If the first feature information is different from the second feature information, the second installation subpackage needs to be updated. If the first feature information is the same as the second feature information, the second installation subpackage does not need to be updated. When the first feature information is different from the second feature information, an update package of the software is generated according to the first installation subpackage.

According to the method provided in this embodiment of the present application, one installation subpackage corresponds to one feature information. The first installation subpackage and the second installation subpackage are compared by comparing the first feature information with the second feature information, the time spent on comparing installation files of two software versions is greatly reduced, resource consumption of a server is reduced accordingly, and an efficiency of generating update packages of software is improved.

Furthermore, each installation subpackage has one identifier, and identifiers of the first software installation package part n and the second software installation package part n′ are the same. The identifier may be a file name or a serial number, etc. The installation package of the software includes a correspondence relationship between identifiers and feature information of the installation subpackages. When generating the update package of the software, the corresponding feature information of the multiple installation subpackages are obtained according to the identifiers of the multiple installation subpackages.

In the embodiments of the present application, a first identifier is obtained from the first software installation package, the first identifier is used to indicate the first installation subpackage. The feature information corresponding to the first identifier is determined as the first feature information which corresponds to the first installation subpackage. An identifier as same as the first identifier is obtained from the second software installation package, and this identifier is the second identifier. The second identifier is used to indicate the second installation subpackage. The feature information corresponding to the second identifier is determined as the second feature information which corresponds to the second installation subpackage. Then, when the first feature information is different from the second feature information, the update package of the software is generated according to the first installation subpackage.

In one embodiment, other installation subpackages for software update in the first software installation package are determined. The first installation subpackage and other installation subpackages are packaged to generate the update package of the software.

In another embodiment, in the event that the first installation subpackage is only used for software update, the installation files in the first installation subpackage are compared with the installation files in the second installation subpackage one by one, and the installation files in the first installation subpackage that are different from the installation files in the second installation subpackage are packaged to generate the update package of the software.

According to the method provided in this embodiment of the present application, the installation files in the first installation subpackage that are different from the installation files in the second installation subpackage are further determined in the event that the first feature information is different from the second feature information. The efficiency of generation of update package of the software is improved, and the amount of data of update packages can also be reduced, and the consumption of network transmission data is reduced.

Particularly, the first feature information is determined according to multiple version information corresponding to the multiple installation files in the first installation subpackage. The second feature information is determined according to multiple version information corresponding to the multiple installation files in the second installation subpackage.

In this embodiment of the present application, one version information description file is generated for each installation subpackage. The version information description file records multiple version information corresponding to the multiple installation files in the installation subpackage. One installation file corresponds to one version information. The version information of the installation file includes a file name, a version number, a version status, etc. A hash value of the version information description file is calculated according to the contents of the version information description file, and the hash value is used as the feature information of the installation subpackage. The feature information of the multiple installation subpackages is recorded in the feature information description file. When the software is released, the software installation package includes various installation subpackages and feature information description files.

Generally speaking, the more the number of the installation subpackages divided within the overall installation package, the more accurate the installation subpackages that are needed to be updated can be determined, and the less the network transmission data consumed during software upgrade. However, when too many installation subpackages are divided, a workload of software maintenance will increase. Therefore, in actual dividing of the installation package of the software, it is necessary to choose the number of installation subpackages according to the actual situation, and determine a suitable balance point.

As an example, this example is illustrated by taking n=4 as an example, before a new software version of the software is released, all installation files to be packaged are marked as f1, f2, f3, f4, . . . , fm in sequence. All installation files are classified into four parts of part 1, part 2, part 3, and part 4. Installation files f1-f30 are classified into part 1, installation files f31-f50 are classified into part 2, installation files f51-f80 are classified into part 3, and installation files f81-fm are classified into part 4. Four identifiers are assigned to part 1, part 2, part 3, and part 4, respectively.

Multiple version information of the installation files f1-f30 is recorded in the version information description file part 1-cnt of part 1. Multiple version information of the installation files f31-f50 is recorded in the version information description file part 2-cnt of the part 2. Multiple version information of the installation files f51-f80 is recorded in the version information description file part 3-cnt of part 3. Multiple version information of the installation files f81-fm is recorded in the version information description file part 4-cnt of the part 4.

A hash value hash 1 of the version information description file part 1-cnt is calculated according to the content of the version information description file part 1-cnt. Similarly, a hash value hash 2 of the version information description file part 2-cnt is calculated according to the content of the version information description file part 2-cnt. A hash value hash 3 of the version information description file part 3-cnt is calculated according to the content of the version information description file part 3-cnt. A hash value hash 4 of the version information description file part 4-cnt is calculated according to the content of the version information description file part 4-cnt. The hash 1, the hash 2, the hash 3 and the hash 4 are taken as the feature information of part 1, part 2, part 3 and part 4, respectively.

Information related to compilation time will be introduced in some software codes. Even if software codes are identical, the hash values of the installation files compiled at different times are also different. If a hash value of an installation subpackage is directly calculated according to the content of the installation subpackage, and this hash value is used as feature information, a problem of misjudgment is caused. This is because that the feature information of the first installation subpackage is different from that of the second installation subpackage, and the determination that the second installation subpackage needs to be updated is made. However, in fact, the first installation subpackage and the second installation subpackage have the same codes and different compilation times, the functionalities of the first installation subpackage and the second installation subpackage are not updated at all. The method provided in this embodiment of the present application can ensure that the generated feature information is the same when the functionality implemented by the installation files in the first installation subpackage and the functionality implemented by the installation files in the second installation package are the same.

When a new software version of the software is released, a software compilation and packaging server compiles the installation subpackage part 1, part 2, part 3, and part 4 to be released respectively, and records the corresponding identifiers and feature information of the installation subpackages in the corresponding feature information description files, respectively. The software compilation and packaging server combines and packages the generated sub modules and feature information description files to generate a new version of installation package of the software to be released. After testing of the new version of installation package of the software to be released is passed, the new version of installation package of the software is pushed to customers. The customers deploy the new version of installation package of the software to a version upgrade server as needed, and a terminal device updates the software through the version upgrade server.

The order in which the compilation system compiles various modules during compilation is not fixed. After recording the multiple version information into the version information description files, the contents in the various version information description files are sorted according to a certain rule to avoid uncertainty factor caused by different statistical orders. For example, if version information occupies one line in the version information description file, the contents in the various version information description files are sorted according to a first letter of each line.

After sorting, the multiple version information corresponding to the multiple installation files in the first installation subpackage corresponds to the first sequence, the multiple version information corresponding to the multiple installation files in the second installation subpackage corresponds to the second sequence. The first sequence is the same as the second sequence, that is, the first installation file in the first installation subpackage is the same as the second installation file in the second installation subpackage, and the order of arrangement of the first installation file is the same as that of the second installation subpackage. When functional codes of the first installation file are the same as that of the second installation file, the first installation file is the same as the second installation file. The first installation file is any one of the multiple installation files in the first installation subpackage.

The first feature information is generated according to the first sequence, and the second feature information is generated according to the second sequence. The method provided in the embodiments of the present application can ensure that the generated feature information is the same when the functionality implemented by the installation files in the first installation subpackage and the functionality implemented by the installation files in the second installation package installation subpackage are consistent.

When the update package of the software is generated, the feature information description files are parsed, and the identifiers and the feature information of the installation subpackages are obtained from the feature information description files. The feature information description file in the first software installation package is parsed, the first identifier is obtained from the feature information description file, and the first feature information is further obtained. The feature information description file in the second software installation package is further parsed, and the identifier as same as the first identifier in the feature information description file of the second software installation package is determined as the second identifier, and the second feature information is further obtained. Alternatively, the feature information description files in the first software installation package are parsed and the first feature information is obtained from the feature information description files. The feature information description files in the second software installation package are parsed and the second feature information is obtained from the feature information description files.

Whether the first feature information is the same as the second feature information is determined. If the first feature information is different from the second feature information, it indicates that the second installation subpackage needs to be updated. If the first feature information is the same as the second feature information, it indicates that the second installation subpackage does not need to be updated. The update package of the software is generated according to the first installation subpackage if the first feature information is different from the second feature information.

Based on the embodiment shown in FIG. 1, a software upgrade method 300 is provided in one embodiment of the present application. As shown in FIG. 3, this method 300 at least includes the following steps:
In a step of S301, a terminal device sends an identifier and current version information of a software to a version upgrade server;
In a step of S302, the version upgrade server determines an installation package corresponding to the latest version of the software according to the identifier, and determines an installation package corresponding to the current version of the software according to the current version information;
In a step of S303, version upgrade server obtains first feature information and second feature information according to the installation package corresponding to the latest version of the software and the installation package corresponding to the current version of the software. The first feature information corresponds to the first installation subpackage, the second feature information corresponds to the second installation subpackage. The first installation subpackage is one installation subpackage in the installation package of the latest version of the software. The second installation subpackage is one installation subpackage corresponding to the first installation subpackage in the installation package of the current version of the software.
In a step of S304, the version upgrade server generates the update package of the software according to the first installation subpackage when the first feature information is different from the second feature information;
In a step of S305, the version upgrade server sends the update package of the software to the terminal devices;
In a step of S306, the terminal device upgrades the software according to the update package;
In a step of S307, the terminal device sends information being indicative of completion of software update to the version upgrade server.

In this embodiment of the present application, the version upgrade server waits for the terminal device to be accessed in real time. When the software needs to be upgraded, the terminal device is connected to the version upgrade server. When the terminal device is successfully connected to the version upgrade server, the terminal device reports the identifier and the current version information V1 of the software to the version upgrade server. The software is upgraded by the server to the latest version by default. The version upgrade server queries the latest version information Vn applicable to the terminal device according to the identifier of the software. The current version is the version of the software before upgrading. The latest version is the upgraded version of the software.

The version upgrade server sends the latest version information Vn to the terminal device, and the terminal device confirms whether or not to perform software update. When the terminal device confirms to perform the software update, the terminal device sends the update confirmation information to the version upgrade server. The version upgrade server determines the installation package corresponding to the current version of the software according to the current version information V1, and determines the installation package corresponding to the latest version of the software according to the latest version information Vn. The version upgrade server generates the update package of the software according to the installation package corresponding to the latest version and the installation package corresponding to the current version.

The version upgrade server sends the update package of the software to the terminal device. The terminal device receives the update package of the software, parses the update package of the software, and performs software upgrading according to the update package. When terminal devices performs the software upgrading, the terminal device directly upgrades the installation subpackages that need to be upgraded, and do not upgrade the installation subpackages that need not to be upgraded, the probability of errors during a software upgrading process is reduced. There is no need to merge the update package of the software with the installation package of the current version of the software first.

After the software upgrading is successfully performed, the terminal device sends update completion information to the version upgrade server. The version server confirms that the terminal device has completed the update of the software. The terminal device is disconnected from the version upgrade server. A update process is terminated by the terminal device. The version upgrade server waits to be connected by the terminal device for the next time.

When generating the update package of the software, the version upgrade server obtains the feature information description file f-c1 that corresponds to the current version information V1 according to the current version information V1, and obtains the feature information description file f-cn that corresponds to the latest version information Vn according to the latest version information Vn. The version upgrade server parses the information recorded in the feature information description files to obtain the feature information of the multiple installation subpackages.

The version upgrade server obtains the feature information vn-part1-c1 of the first installation subpackage and the feature information v1-part1-c1 of the second installation subpackage, and determines whether the feature information v1-part1-c1 and the feature information vn-part1-c1 are the same by comparison, and determines whether the second installation subpackage needs to be updated when the software is upgraded from the current version V1 to the latest version Vn. If the feature information v1-part1-c1 and the feature information vn-part1-c1 are different, the second installation subpackage needs to be updated. If the feature information v1-part1-c1 and the feature information vn-part1-c1 are the same, updating of the second installation subpackage is unnecessary. Other installation subpackages for upgrading in the installation package corresponding to the latest version of the software are determined in sequence by using the same method when the software is upgraded from the current version V1 to the latest version Vn.

After the installation subpackages for upgrading are determined, the version upgrade server packages the installation subpackages for upgrade and generates an update package of the software. The update package of the software may only contain one installation subpackage, and may also contain multiple installation subpackages or all installation subpackages.

Regarding other details that are not described in the method 300, reference can be made to the description in the aforesaid method 100. For conciseness, the details are not repeatedly described herein.

According to the method provided in the embodiment of the present application, the update package of the software is dynamically generated by the version upgrade server during the software upgrading of the terminal device, the problem that incremental upgrades can only be performed on a specified software version is solved.

When a software of the terminal device needs to be upgraded, the version upgrade server will automatically obtain an installation package of a new version of the software and an installation package of an old version of the software, and generate an update package for upgrading from the old version of the software to the new version of the software. Therefore, when a version of the software is released, it only needs to release the complete software installation package, without the need of providing update packages for incremental upgrades, a version releasing process can be simplified, and a waste of storage space caused by storing multiple update packages on the server is avoided.

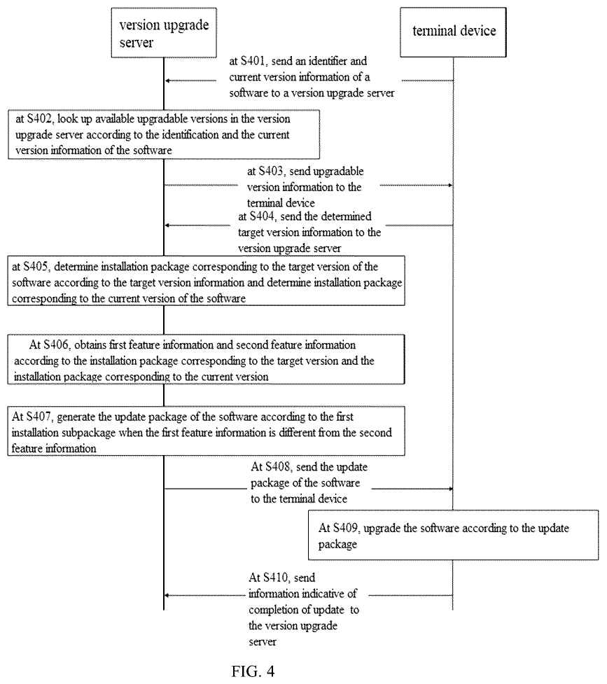

A software upgrading method 400 is further provided in one embodiment of the present application. As shown in FIG. 4, this method at least includes the following steps:

In a step of S401, a terminal device sends an identifier and current version information of a software to a version upgrade server;

In a step of S402, the version upgrade server looks up available upgradable versions in the version upgrade server according to the identification and the current version information of the software.

In a step of S403, upgradable version information is sent to the terminal device.

In a step of S404, the terminal device sends the determined target version information to the version upgrade server;

In a step of S405, the version upgrade server determines an installation package corresponding to the target version of the software according to the target version information, and determines an installation package corresponding to the current version of the software according to the current version information.

In a step of S406, the version upgrade server obtains first feature information and second feature information according to the installation package corresponding to the target version and the installation package corresponding to the current version. The first feature information corresponds to the first installation subpackage, the second feature information corresponds to the second installation subpackage. The first installation subpackage is an installation subpackage in the installation package of the target version of the software. The second installation subpackage is an installation subpackage that corresponds to the first installation subpackage in the installation package of the current version of the software.

In a step of S407, the version upgrade server generates the update package of the software according to the first installation subpackage when the first feature information is different from the second feature information;

In a step of S408, the version upgrade server sends the update package of the software to the terminal device.

In a step of S409, the terminal device upgrades the software according to the update package.

In a step of S410, the terminal device sends information indicative of completion of update of the software to the version upgrade server.

In this embodiment of the present application, the terminal device reports the current version information of the software to the version upgrade server and looks up the available upgradable version(s) in the version upgrade server. The number of the available upgradable version(s) in the version upgrade server may have one, two, or more than two. The version upgrade server sends the multiple upgradable versions to the terminal device. The terminal device selects one software version as the target version and sends the determined target version information to the version upgrade server. The current version is the version of the software before upgrading. The target version is the upgraded version of the software.

The version upgrade server generates the update package of the software according to the current version information and the target version information of the software. The version upgrade server sends the update package of the software to the terminal device. The terminal device receives and parses the update package of the software, and upgrades the software according to the update package.

Regarding other details that are not described in the method 400, reference can be made to the descriptions in the method 100. For conciseness, the details that are not described in the method 400 will not be repeatedly described herein.

Due to long usage time of some terminal devices, the terminal devices may have insufficient storage capacities or processing capacities. If the software version is upgraded to the latest version, a condition that the software is incompatible with the terminal device or the operation of the terminal device is stuck may be caused. In the embodiments of the present application, one software version is selected as the target version by the terminal device, the requirement of upgrading of the terminal device can be better met.

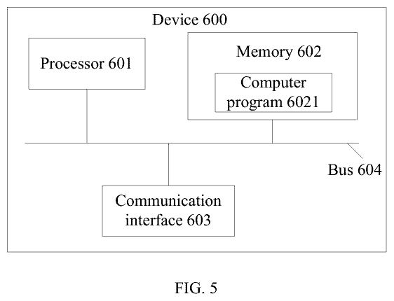

FIG. 5 illustrates a structural schematic diagram of a device 600 provided in one embodiment of the present application. As shown in FIG. 5, the device 600 includes a processor 601, a memory 602, a communication interface 603, and buses 604. The processor 601, the memory 602, and the communication interface 603 are communicated with each other through the buses 604. Communication of the processor 601, the memory 602 and the communication interface 603 can also be implemented by other method such as wireless transmission. The memory 602 is configured to store an instruction, and the processor 601 is configured to execute the instruction stored in the memory 602. The memory 602 stores a program code 6021, and the processor 601 can invoke the program code 6021 stored in the memory 602 so as to execute the method for generating the update package of the software shown in FIG. 1, or execute the software upgrading method shown in FIG. 3, or execute the software upgrading method shown in FIG. 4.

It should be understood that, in the embodiments of the present application, the processor 601 can be central processing unit (CPU), and can also be other general purpose processor, digital signal processor (DSP), application specific integrated circuit (ASIC), field-programmable gate array (FGPA), or some other programmable logic devices, discrete gate or transistor logic device, discrete hardware component, etc. The general purpose processor may be a microprocessor, as an alternative, the processor can also be any conventional processor, or the like.

The memory 602 can include read-only memory (ROM) and random access memory (RAM), and provides instructions and data to the processor 601. The memory 602 can also include a non-volatile random access memory. The memory 602 may be a volatile or a non-volatile memory. Alternatively, the memory 602 can include the volatile memory and the non-volatile memory. The non-volatile memory can be a read-only memory (ROM), a programmable read-only memory (PROM), an erasable programmable read-only memory (EPROM), an electrically erasable programmable read-only memory (EEPROM), or a flash memory. The volatile memory can be a random access memory (RAM) that serves as an external cache. By way of illustration rather than limitation, RAM in various forms, such as a static random access memory (SRAM), a dynamic random access memory (DRAM), a synchronous dynamic random access memory (SDRAM), a double data date SDRAM (DDR SDRAM), an enhanced synchronous dynamic random access memory (ESDRAM), a synchlink dynamic random access memory (SLDRAM) and a direct rambus random access memory (DRRAM), are available.

The buses 604 can not only include a data bus, but also include a power bus, a control bus, and a status signal bus. However, for clarity, the various buses are all marked as bus 604 in FIG. 5.

The computer can be a general-purpose computer, a specialized computer, a computer network, or other programmable devices. The computer instructions can be stored in a computer-readable storage medium or be transmitted from one computer-readable storage medium to another computer-readable storage medium. For example, the computer instructions can be transmitted from a website, a computer, a server or a data center to another website site, another computer, another server or another data center through a wire transmission method such as a coaxial cable, a fiber optic, a digital subscriber line (DSL), or through a wireless transmission method such as infrared, wireless, microwave, etc. The non-transitory computer-readable storage medium can be any available medium that can be accessed by the computer, or a data storage device such as a server or a data center containing one or more sets of available media. The available media can be a magnetic medium (e.g., a floppy disk, a hard disk, a magnetic tape), an optical medium (e.g., DVD), or a semiconductor medium. The semiconductor medium can be a solid state drive (SSD).

The foregoing embodiments are only intended to explain the technical solutions of the present application, rather than limiting the technical solutions of the present application. Although the present application has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present application, and thus should all be included in the protection scope of the present application.

1. A method for generating an update package of software implemented by a version upgrade server, wherein each installation package of the software comprises multiple installation subpackages, and each of the multiple installation subpackages comprises multiple installation files; the method comprising:
receiving, by the version upgrade server, an identifier and current version information of the software from a terminal device;
determining, by the version upgrade server, an installation package corresponding to a latest version of the software according to the identifier, and determining an installation package corresponding to a current version of the software according to the current version information;
obtaining, by the version upgrade server, first feature information and second feature information according to the installation package corresponding to the latest version of the software and the installation package corresponding to the current version of the software, wherein the first feature information corresponds to a first installation subpackage, the second feature information corresponds to a second installation subpackage, the first installation subpackage is an installation subpackage in an installation package of an upgraded software version of the software, and the second installation subpackage is an installation subpackage corresponding to the first installation subpackage in an installation package of a software version of the software before upgrading; and
generating, by the version upgrade server, an update package for the software according to the first installation subpackage when the first feature information is different from the second feature information.

2. The method according to claim 1, wherein said obtaining, by the version upgrade server, the first feature information and the second feature information according to the installation package corresponding to the latest version of the software and the installation package corresponding to the current version of the software comprises:
by the version upgrade server, obtaining a first identifier from a first software installation package and obtaining a second identifier from a second software installation package, wherein the first software installation package is the installation package corresponding to the upgraded software version of the software, and the second software installation package is the installation package corresponding to the software version of the software before upgrading; the first identifier is used to indicate the first installation subpackage, the second identifier is used to indicate the second installation subpackage, and the first identifier is the same as the second identifier; and
by the version upgrade server, determining feature information corresponding to the first identifier as the first feature information, and determining feature information corresponding to the second identifier as the second feature information.

3. The method according to claim 1, wherein said generating, by the version upgrade server, the update package of the software according to the first installation subpackage comprises:
packaging, by the version upgrade server, an installation file of the first installation subpackage that is different from the second installation subpackage to generate the update package of the software.

4. The method according to claim 2, wherein the first feature information is determined according to multiple version information corresponding to multiple installation files in the first installation subpackage.

5. The method according to claim 4, wherein the second feature information is determined according to multiple version information corresponding to multiple installation files in the second installation subpackage.

6. The method according to claim 5, further comprising: generating the first feature information according to a first sequence, and generating the second feature information according to a second sequence when a first installation file in the first installation subpackage is the same as a second installation file in the second installation subpackage; wherein the first sequence is the same as the second sequence, the first sequence corresponds to multiple version information that corresponds to multiple installation files in the first installation subpackage, and the second sequence corresponds to multiple version information that corresponds to multiple installation files in the second installation subpackage; the first installation file is any one of the multiple installation files in the first installation subpackage.

7. A device, comprising a memory, a processor, and a computer program stored in the memory and executable by the processor, wherein the processor is configured to, when executing the computer program, implement the method according to claim 1.

8. A non-transitory computer-readable storage medium, which stores a computer program, that, when being executed by a processor, causes the processor to implement the method according to claim 1.
